(19) United States
(12) Patent Application Publication
(10) Pub. No.: US 2024/0430328 A1
(43) Pub. Date: Dec. 26, 2024

(54) USER IDENTIFICATION AND ACTIVITY MONITORING SERVICE

(71) Applicant: GetEmails LLC, Austin, TX (US)

(72) Inventors: Adam Robinson, Austin, TX (US); Tate Blahnik, San Carlos, CA (US)

(73) Assignee: GetEmails LLC, Austin, TX (US)

(21) Appl. No.: 18/822,740

(22) Filed: Sep. 3, 2024

Related U.S. Application Data
(63) Continuation-in-part of application No. 17/993,860, filed on Nov. 23, 2022.
(60) Provisional application No. 63/251,378, filed on Oct. 1, 2021.

(51) Int. Cl. H04L 67/1396; G06Q 30/0601

(52) U.S. Cl. CPC H04L 67/1396; G06Q 30/0633

(57) ABSTRACT

Systems, methods and apparatuses are described herein to identify visitors to a website or other network location across any number of user devices and applications without the use of cookies. The service may determine user information including an email address associated with identified visitors and may further provide such user information to one or more vendors for sales and marketing purposes. The service may further monitor various online activities of users for reporting and billing purposes.

### INTRODUCTION

As ecommerce has evolved into a widespread means of doing business, competition among online merchants has increased dramatically. Email marketing and online advertising have proven to be effective ways for vendors to reach potential purchasers of goods and services. And techniques are continuously being developed to accurately identify users and understand their preferences to improve targeting efforts.

Traditionally, ecommerce vendors have relied on the use of cookies for user identification and tracking. Cookie identifiers generated and used by web browsers, mobile applications, and web service providers allow vendors to identify specific user devices and to collect various activity information therefrom. Vendors may then aggregate such information across each of a user's devices to generate a profile that may be used for sales and marketing purposes.

Unfortunately, the efficacy of cookies has significantly declined in recent years due to an explosion in both the number of devices and Internet access channels employed by individual users. Users often employ multiple devices to access online material, and they do so via a plethora of media channels, such as browsers, applications (“Apps”), and other standalone software. Each of a user's Apps and browsers may utilize a different identification technique, which may generate different identifiers that, in turn, may be associated with the same computing device. As different device identities are established for the same computing device, there may be a resulting high degree of fragmentation across different applications and other media contexts. As a result, vendors often maintain different device identities for a single device and/or associate those different device identities with an inaccurate user.

Accordingly, there is a need for systems and methods that allow vendors to identify and contact unannounced users, based on user device information, without relying on third-party cookies or input forms. It would be further beneficial if such systems could provide insights into online activities of such users to assist vendors in sales and marketing efforts.

### SUMMARY

Aspects of the present disclosure relate to a system for user identification and monitoring, the system including: a processor; a memory; and instructions stored on the memory, the instructions, when executed by the processor, cause the processor to: identify visitors to a website or other network location across a plurality of user devices and applications, wherein identifying visitors to the website or other network locations across a plurality of user devices and applications includes: a script management module, wherein the script management module manages a number of vendor-specific scripts; a user identification module, wherein the user identification module uniquely identifies visitors to a network based on a user's selection to opt in for one or more promotions and associate cach identified visitor with a unique identifier; an activity tracking module, wherein the activity tracking module monitors activities of visitors identified by the user identification module; a suppression module, wherein the suppression module receives and determines suppression information relating to a user corresponding to user records stored in a user database; an attribution module, wherein the attribution module associates an abandoned eCommerce cart made by the visitor at a network location with a provider of a service based on predetermined attribution criteria; and a reporting module, wherein the reporting module transmits or displays some or all user information contained in one or more of the user records via one or more reports, notifications, alerts, webhooks, or API calls.

Aspects of the present disclosure relate to a system, wherein the script management module further manages configuration settings and data supporting the vendor-specific scripts.

Aspects of the present disclosure relate to a system, wherein the script management module further generates a unique script for each vendor.

Aspects of the present disclosure relate to a system, wherein the script management module further generates a unique script for each vendor.

Aspects of the present disclosure relate to a system, wherein the user identification module further receives user information, determines a subset of the received user information that uniquely identifies a client device or user of the client device, and matches the subset of the received user information to the user records.

Aspects of the present disclosure relate to a system, wherein the user identification module further creates the user record in the user database corresponding to the unique identifier.

Aspects of the present disclosure relate to a system, wherein the activity tracking module further tracks visits to a network location, and use and conversion activities performed by a user.

Aspects of the present disclosure relate to a system, wherein the activity tracking module associates the visit, use, and conversion information with the corresponding user record on the user database.

Aspects of the present disclosure relate to a system, wherein the activity tracking module further identifies and tracks activities performed by the user based on one or more predetermined events.

Aspects of the present disclosure relate to a system, wherein the reporting module further determines aggregate information across a user population, or subset thereof, based on the user records and tracked activities performed by the user.

Aspects of the present disclosure relate to a method for tracking user activities across user devices, the method including: identifying visitors to a website or other network location across a plurality of user devices and applications, wherein identifying visitors to the website or other network locations across a plurality of user devices and applications includes: assigning the user to the unique identifier, by the user identification module, configured to be linked to a characteristic of the website; managing, via a script management module, a number of vendor-specific scripts; logging, via user activity, items put into an eCommerce cart on the website; logging, via user activity, an abandonment of the eCommerce cart; uniquely identifying, via a user identification module, visitors to a network and associate each identified visitor with a unique identifier; monitoring, via an activity tracking module, activities of visitors identified by the user identification module; receiving and determining, via a suppression module, suppression information relating to a user corresponding to user records stored in a user database; associating, via an attribution module, the abandoned eCommerce cart made by the visitor at a network location with a provider of a service based on predetermined attribution criteria; and transmitting or displaying, via a reporting module, some or all user information contained in one or more of the user records via one or more reports, notifications, alerts, webhooks, or API calls.

Aspects of the present disclosure relate to a method, wherein the method further includes managing, via the script management module, configuration settings and data supporting the vendor-specific scripts.

Aspects of the present disclosure relate to a method, wherein the method further includes generating, via the script management module, a unique script for each vendor.

Aspects of the present disclosure relate to a method, wherein the method further includes generating, via the script management module, a unique script for each vendor.

Aspects of the present disclosure relate to a method, wherein the method further includes receiving, via the user identification module, user information, determining a subset of the received user information that uniquely identifies a client device or user of the client device, and matching the subset of the received user information to the user records.

Aspects of the present disclosure relate to a method, wherein the method further includes creating, via the user identification module, the user record in the user database corresponding to the unique identifier.

Aspects of the present disclosure relate to a method, wherein the method further includes tracking, via the activity tracking module, visits to a network location, and use and conversion activities performed by a user.

Aspects of the present disclosure relate to a method, wherein the method further includes associating, via the activity tracking module, the visit, use, and conversion information with the corresponding user record on the user database.

Aspects of the present disclosure relate to a method, wherein the method further includes identifying and tracking, via the activity tracking module, activities performed by the user based on one or more predetermined events.

Aspects of the present disclosure relate to a method, wherein the method further includes determining, via the reporting module, aggregate information across a user population, or subset thereof, based on the user records and tracked activities performed by the user.

Additional aspects related to this disclosure are set forth, in part, in the description which follows, and, in part, will be obvious from the description, or may be learned by practice of this disclosure.

It is to be understood that both the forgoing and the following descriptions are exemplary and explanatory only and are not intended to limit the claimed disclosure or application thereof in any manner whatsoever.

### BRIEF DESCRIPTION OF THE DRAWINGS

FIG. 1 shows an exemplary system 100 in accordance with one or more embodiments presented herein.

FIG. 2 shows an exemplary method 200 of identifying a website user, determining user information including an email address for the identified user, and providing the user information to a vendor.

FIG. 3 shows an exemplary method 300 of monitoring user activity based on predetermined events in accordance with one or more embodiments presented herein.

FIG. 4 shows an exemplary computing device 400 and modules 450 in accordance with one or more embodiments presented herein.

### DETAILED DESCRIPTION

Various user identification and monitoring services, systems, computer-implemented methods, apparatuses and software applications are described herein. The disclosed services may be configured to identify visitors to a website or other network location across any number of user devices and applications without the use of cookies. The services may determine user information comprising an email address associated with identified visitors (i.e., “leads”) and may further provide such user information to one or more vendors for sales and marketing purposes.

In certain embodiments, the disclosed services may recognize a lead who returns to a given network location and may monitor various online activities of the returning lead for reporting and billing purposes. For example, the service may track visit, use or conversion activities performed by returning leads and store such information in a database. Some embodiments of the service may include an activity tracking module configured to identify and recognize specific activities performed by visitors and leads as being identification events, order events, suppression events, or other activities to be tracked. And, in some embodiments, the service may employ information from any number of connected third-party systems to validate and/or enhance user information associated with leads.

As used herein, the term “visitor” may refer to a unique visitor to a website, web service, or any other network location associated with a vendor. In some cases, the term “visitor” as used herein may carry a meaning synonymous with terms such as “user,” “person,” or “individual.”

As used herein, the term “lead” may refer to a visitor that has been identified by the service such that at least the visitor's email address is known. A lead who returns to a given network location after their user information has been provided, by the service, to a vendor may be referred to as a “returning lead.”

### System

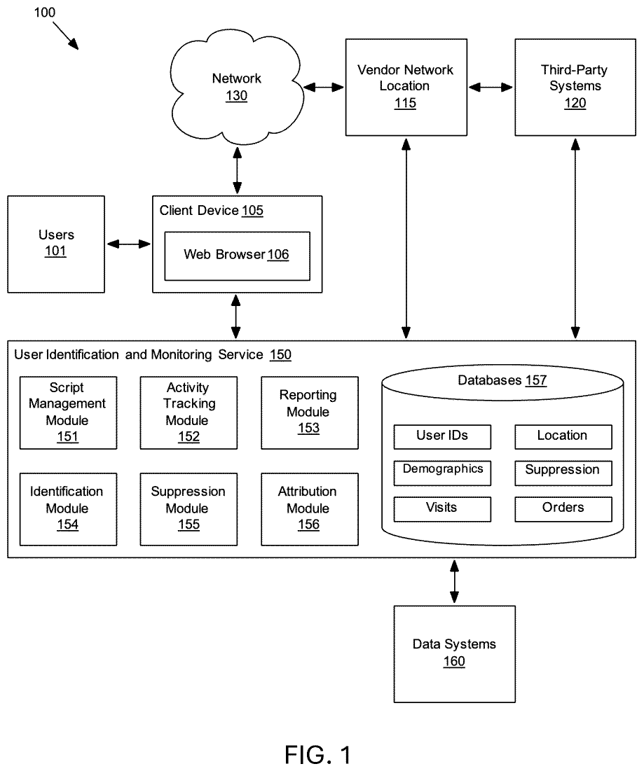

Referring to FIG. 1, an exemplary system 100 is illustrated. As shown, various entities comprise an online environment in which users 101 operate client devices 105 in order to interact with electronic content provided by a vendor at a network location 115. The users 101 (i.e., visitors and leads) typically operate client devices 105 by interacting with software on the device, such as a web browser 106 that provides navigational and display functionality for content delivered to the device.

Generally, the client devices 105 may send data to one or more devices (e.g., a server) at a vendor network location 115, and may receive data therefrom. The client devices 105 may be any electronic device configured to send, receive, and/or display messages and content using an electronic network 130, such as a desktop computer, laptop, notebook, tablet computer, smartphone, personal data assistant or navigation system. For example, when the client device 105 is a smartphone, the device may be an iPhone or Android-based phone, and the network 130 may be a cellular telephone network or a wireless network. As another example, the client device may be a desktop computer and the network 130 may be a wired Ethernet network connected to the Internet.

As shown, a communications network 130 may connect the client device 105 with the other entities in the environment. Communication among the entities may take place via any media such as standard telephone lines, a local or wide-area network (LAN or WAN links such as T1, T3, 56 kb, X.25), broadband connections (ISDN, Frame Relay, ATM), wireless links (cellular, 802.11, Bluetooth, etc.), and others. Preferably, the network 130 facilitates the transmission of TCP/IP protocol communications and HTTP/HTTPS requests made by the web browser 106. However, any suitable network may be used. Non-limiting examples of networks that can serve as or be part of the communications network 130 include wireless or wired intranet, LAN or WAN, and/or the Internet.

Vendors generally manage, maintain, develop, aggregate and/or collect content that may be delivered to the client devices 105 via a website, web service, or any other network location 115. Exemplary vendor network locations 115 may include any server accessed as a result of a user's action on a client device, even if the user is not aware of the client-server interaction. Such user interactions may be performed via a web browser, a web application, a mobile device application, a desktop application or any other mechanism.

A vendor may have relationships with any number of third-party systems 120 that receive information from and/or transmit information to the network location 115. Exemplary third-party systems 120 may include, but are not limited to, customer relationship management (“CRM”) systems, advertising platforms, social media platforms, email systems and databases, analytics platforms, billing, accounting and/or payment systems, file sharing systems, etc.

### User Identification and Monitoring Service

As shown, a user identification and monitoring service 150 is provided to facilitate the identification of website visitors and the monitoring of user activity via interactions with various entities within the online ecosystem. In one embodiment, the service 150 comprises multiple functional components (e.g., modules 151-156, database 157, etc.) making up a data collection, analysis and reporting infrastructure. In some embodiments, these components may include, but are not limited to: a script management module 151, an activity tracking module 152, an identification module 154, a suppression module 155, a reporting module 153, and/or an attribution module 156. Each of these components may transmit data to and/or receive data from one or more databases 157.

It will be appreciated that the components of the user identification and monitoring service 150 can be provided to one or more of the entities operating within the online environment to operate remotely. Additionally, or alternatively, any number of the components may operate as a centrally-managed service.

### Databases

As shown, the service may comprise any number of databases 157 configured to receive various information from and/or transmit various information to one or more of the modules 151-156, the vendor network location 115, any third-party systems 120 in communication with the network location, and/or any data systems 160 in communication with the service 150.

As discussed in detail below, the database 157 may store/receive user records, where each user record corresponds to a unique individual (i.e., a visitor or lead). Generally, each user record may comprise user information including, but not limited to: an email address, a hash of the email address (e.g., MD5 hash), user device parameters and fingerprints, personal information, user activity information relating to any number of visits, suppression records, order information, location information, and/or other information.

In one embodiment, the service 150 may receive user information from various data sources and automatically create and/or update user records stored in the database 157 (i.e., based on the received information). As an example, assume the service receives the following user information about an individual: a name, email address, and phone number from a CRM system; a home address and a phone number associated with the email address from a billing system; and a username associated with the email address from a social networking system. In such case, the service may employ the received information to create or update a user record corresponding to the individual in the database. Upon creating or updating the user record, it will comprise at least the email address, a hash of the email address, and one or more of the name, the home address, the phone number, and the username. It will be appreciated that the service may also send user information stored in the database to any of the above data sources.

In some embodiments, the service may, additionally or alternatively, transmit any user information associated with a user record to various systems (e.g., a vendor network location and/or a third-party system associated therewith). For example, the service may transmit some or all information associated with a given user record (e.g., a hashed or plain-text email address) to a data system in order to query the data system for additional user information. Exemplary data systems 160 may include, but are not limited to: third-party email validation systems (e.g., ZeroBounce, Klean13, etc.), third-party user resolution systems (e.g., Infutor) and/or others.

### Script Management Module

Generally, the service 150 may employ vendor-specific scripts (e.g., JavaScript files) or other software components installed at a network location 115 to collect and report data and events back to one or more databases 157 and/or to other components of the service. The scripts may include various parameterized HTTP requests that are made by the script. Generally, the scripts may be parameterized with variables that may be used to inform the service and/or vendors about the activities and attributes of visitors and leads.

In one embodiment, the service 150 comprises a script management module 151 adapted to manage any number of vendor-specific scripts. This module 151 may manage configuration settings and data supporting the scripts, and may make such resources available to vendors for inclusion in their network locations.

The script management module 151 may be adapted to generate a unique script for cach vendor who utilizes the service 150. Each script may, for example, be hosted at a unique URL such that the corresponding vendor may import the script to one or more network locations. Such configuration allows for dynamic updating of the vendor's script. For example, a vendor may turn off collection of user information via a client application (discussed below). In turn, the vendor's script may be automatically updated such that collection is disabled, while still allowing for other functionality within the script to continue running (e.g., suppression, validation of installation, etc.).

### User Identification Module

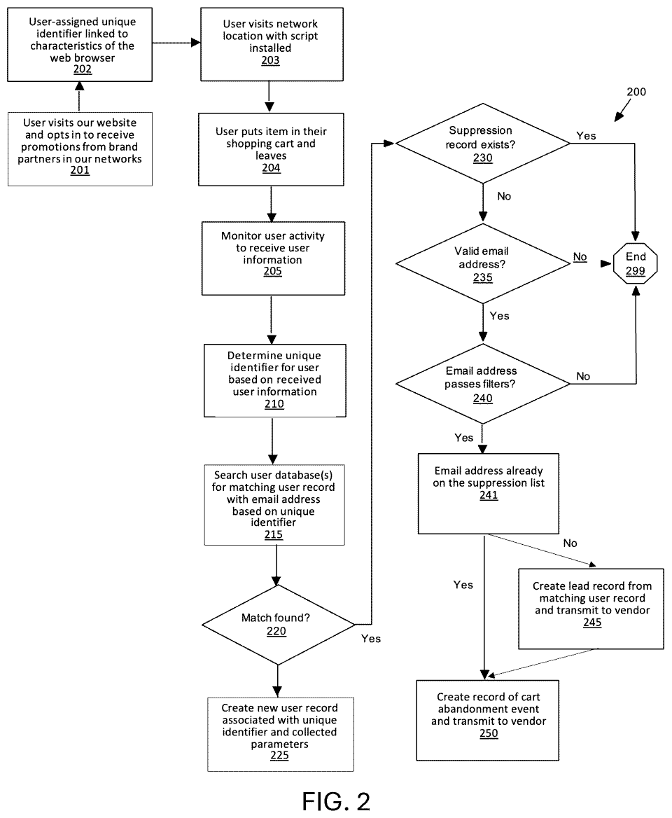

The service may comprise an identification module 154 configured to uniquely identify visitors to a network location and to associate identified visitors (i.e., leads) with unique identifiers linked to characteristics of the web browser. As explained in detail below with respect to FIG. 2, the identification module 154 may generally receive user information (e.g., via the script installed at the network location), determine a subset of the received user information that uniquely identifies a client device and/or a user who operates such device (e.g., email address, device fingerprints, etc.), and match such identifying information to a user record stored in a user database. This may be done once the user adds an item to their eCommerce shopping cart, by selecting an indicator (e.g., a virtual button) that puts the item into the eCommerce shopping cart.

In certain embodiments, the identification module 154 may be further configured to create user records in the database corresponding to unique first-time visitor. To that end, the module may be configured to perform digital identification resolution processes to receive and link disparate identification data elements (e.g., personal information, device parameters, etc.) from multiple sources and correlate such parameters to a user record associated with a single individual.

### Activity Tracking Module

The service 150 may include an activity tracking module 152 configured to monitor activities of visitors and leads identified by the identification module 154. The activity tracking module 152 may be configured to track any or all visits, use or conversion activities performed by users. And the module may associate such visit information with a corresponding user record in the database 157.

Typically, a single user 101 may interact with a network location 115 many times. As used herein, each visit by a given user may be referred to as a “visit.” In some embodiments, a visit may be an individual request (e.g., an individual GET request from a particular device to a particular URL). In other embodiments, a visit may be a collection of requests received within a particular span of time. For example, within one browsing session, a user's device 105 may send thousands of requests, even if the browsing session only lasts for a few minutes. Nonetheless, an entire browsing session may be recorded as a single visit for the purposes of some embodiments herein.

In one embodiment, the activity tracking module 152 may include features and systems for identifying and tracking activities performed by users based on predefined events. For example, the module may monitor and record information relating to various non-identifying transactions within a network location, such as: adding items to the website's eCommerce shopping cart, navigating through a sequence of web pages to obtain desired content, performing searches for user specified information, sending or retrieving a message without including personal information, and so forth.

As another example, the activity tracking module 152 may monitor and record information relating to various identifying events and activities. Generally, an identifying event refers to a transaction with a network location where a user discloses personal information including an email address to a vendor. Exemplary identifying events may include, but are not limited to, submitting a contact form, subscribing to a service, making a reservation, and signing up for an account. Identifying activities may also include order or purchase transactions, such as purchasing goods or services in one-time transactions or as one or more up-sells (e.g., a premium add-on service).

In some embodiments, the activity tracking module 152 may associate metadata about a user or about the user's unique visits in the user database 157. Such metadata may be determined by the activity tracking module (or another module) and may include information such as the items in the eCommerce shopping cart, date and time of the lead's first visit, the date and time of some or all return visits by the lead, a number of return visits, a specific URL(s) visited, a referrer or channel that directed the user to the network location, user device parameters (e.g., a web browser used, a computer operating system, etc.), information from a social networking site, an IP address, geo-location data, etc.

A typical HTTP request includes the Uniform Resource Locator (URL) of the web page to be accessed and a “User-Agent” header indicating the browser sending the request and the operating system of the computer on which the browser is running. In some browsers, the language of the operating system may also be sent in the User-Agent header, while in others the OS language may be sent in an Accept-Language header. The Accept header contains the MIME types supported by the browser. The IP address of the client is part of the underlying IP packet. If the client is accessing the Internet through a proxy server, then it is the proxy's IP address which is sent as part of the underlying IP packet. Some proxies report the client's IP address in an additional HTTP header dedicated for that purpose, for example the “Forwarded-For” header or “Client-IP” header. Any of these pieces of information, data derived from these, or any other information may be determined by the activity tracking module (or another module) and associated with a user record stored in the database.

### Suppression Module

In some embodiments, the service 150 may further comprise a suppression module 155. Generally, this module 155 may receive and/or determine suppression information relating to various users corresponding to user records stored in the user database. The suppression information may be employed to generate suppression records associated with user records, which inform the service that a user's information should not be shared with a vendor.

In one embodiment, the service 150 may receive suppression information from a vendor network location 115 or via a vendor's third-party system 120. For example, the service may receive user opt-out information, global opt-out information, etc. via a database file or API call.

In another embodiment, the service may receive suppression information from a user 101 via a client device 105. For example, the service may provide functionality to allow end users to interact with various notifications displayed on a vendor's network location 115 (e.g., a website). In such cases, a user may select an opt-out option which is transmitted to the service and associated with the corresponding user record in the database 157.

It will be appreciated that the service 150 may provide vendors with the capability to display notifications to users and collect user input relating to privacy preferences. In such cases, the service may provide visual templates (e.g., CSS style sheets, HTML templates, etc.) for creating pop-up notifications and other messages. The notifications may include text, graphics and links to other sites or pages with additional information or forms related to privacy and advertising practices of the provider. The service may also allow vendors to define how and when the notifications are delivered.

In yet another embodiment, the service may automatically create a suppression record for a user. For example, to avoid sharing duplicative leads, the system may create a suppression status for a particular lead upon sharing the lead with the vendor. As another example, the system may create a suppression record for a lead upon determining that the email addresses associated with the lead cannot be verified (discussed below). As yet another example, the system may associate a suppression record with a lead upon determining that the lead already exists in a vendor's CRM system or other database. And as yet another example, the system may associate a suppression record with a lead upon determining that the lead has performed an identifying transaction (e.g., providing an email address to the vendor).

### Attribution Module

In one embodiment, the user identification and monitoring service 150 may comprise an attribution module 156. As discussed below, this module 156 may be configured to associate purchases or abandoned purchases made by leads at the network location with a provider of the service 150 based on predetermined attribution criteria.

For example, the attribution module 156 may receive or determine abandoned order information for one or more orders or abandoned orders (e.g., the possible sales price, units or abandoned units, purchase date or canceled purchase date, entered billing information, purchase user information or abandoned purchaser user information, etc.). The module may then attribute the sales or abandoned sales to the service provider when the purchaser or abandoned purchaser is a lead whose information was shared with the vendor at least a predetermined amount of time before the purchase or abandoned purchase (e.g., at least 12 hours or at least 24 hours prior to the purchase).

### Reporting Module

As shown, the service may further comprise a reporting module 153. Generally, this module 153 may be configured to aggregate, summarize, analyze, and/or format user information associated with any number of leads and facilitate the sharing of such information.

In one embodiment, the reporting module 153 may transmit or display some or all user information contained in one or more of the user records via one or more reports, notifications, alerts, webhooks, or API calls. For example, the module may transmit one or more of the user records to a third-party system associated with the vendor (e.g., CRM systems, email marketing tools, ad platforms, etc.). As another example, the user records may be transmitted to, or otherwise accessed by, user devices associated with the provider of the service and/or the vendor.

In another embodiment, the reporting module 153 may determine aggregate information across a user population or a subset thereof based on the user records and/or any activity information associated therewith. For example, the reporting module may generate various reports based on aggregate lead, order/purchase or abandoned order/purchase, and/or billing information (e.g., return on investment, percent sales attributable to the service, etc.). It will be appreciated that aggregated lead and conversion data may be analyzed and presented by the reporting module using any suitable statistical or other techniques available.

### Internet Communications Technologies

Internet communications technologies generally use various standardized protocols designed to facilitate client-server interactions during which client devices send a request (or other information) to a server at a network location and the server responds with additional information or by performing some action. For example, most web-based interactions are performed using HTTP (hypertext transfer protocol) to allow users to view and manipulate information, and perform other actions with a website or other network location.

A typical web page is written in a markup language such as the Hypertext Markup Language (HTML) and/or a hypertext scripting language such as PHP. A web page typically includes a number of embedded objects (e.g., images, videos, client-executable scripts) referenced by respective Uniform Resource Locators (URLs). The web page itself is generally referenced by a URL, as well. When a user provides a URL of a web page to a web browser (e.g., by clicking a hyperlink identifying the URL to that web page, by directly typing in the URL of the web page or by otherwise directing a web browser or other application to request data from the URL), the web browser performs a detailed sequence of processing tasks to obtain that web page.

As an example, if the URL of the web page identifies a domain name of a server computer system on the Internet, the web browser first performs a Domain Name Service (DNS) lookup of the domain name to resolve this alphanumeric name into the Internet Protocol (IP) address of the web server on the Internet that can serve the web page referenced by the URL. Once this DNS lookup is complete, the web browser establishes a connection to the web server (e.g., a Transmission Control Protocol or TCP connection) and uses a Hypertext Transport Protocol (HTTP) to transmit a web page GET request over the connection to the web server. The HTTP GET request contains the URL of the web page to be served by the server. The web server receives this HTTP GET request, obtains or dynamically generates the web page, and returns the web page as HTML to the web browser in an HTTP response message over the connection.

As the web browser receives the HTML for the web page, the HTML of the web page may include many embedded URLs that define other objects within the web page to be obtained by the web browser. As an example, an image, script or other object embedded within the web page is typically referenced with an embedded URL that specifies a server, and location (i.e., filename and directory path) within the server of that object. As the web browser encounters embedded URL's within the web page, the web browser repeats the sequence of processing described above to retrieve cach embedded object from the respective URL. This can include performing additional DNS lookups, establishing server connections, and initiating an HTTP GET request (or POST or other request) to obtain the content associated with the embedded URL. Modem web pages often contain many embedded objects and URLs that reference these objects, often specifying different server computer systems from which to obtain these objects. As a result, the process of obtaining the complete content associated with a single web page including all embedded objects involves significant processing and communications activities.

Other internet communications between user-controlled client devices and servers at network locations may use other protocols and technologies. For example, many websites and web-based applications use Adobe Flash, HTML5, ActiveX, Java, PHP, etc. In addition to these network protocols, many mobile devices communicate with wireless networks using long-range wireless communications technologies such as GPRS, EDGE, UMTS, WCDMA, HSDPA, EVDO, WIMAX, and LTE, or short-range communication protocols such as WiFi, Bluetooth, RFID, NFC, etc. Some mobile devices may also be configured to run applications that communicate with network locations over one or more networks using WAP (wireless application protocol) or others.

It will be appreciated that, in some embodiments, components of a user identification and monitoring service 150 may utilize any suitable hardware configuration. For example, in some embodiments two or more components, such as a database server and an application server, may be implemented in a single hardware server device. In other embodiments, an application server and a database server may each comprise several hardware servers, depending on the anticipated request volume and other requirements of a particular system. Any other arrangement using any number of physical or virtual servers may alternatively be used. For example, in some embodiments, some system components may use inexpensive commodity hardware. In some embodiments, some system components may reside in a “cloud” or virtual environment in which resources are shared, such as a network and/or virtual machines.

Various databases 157 and database systems may be used in the systems and methods herein to track and store information about individual network location visitors, leads, conversions, and any other information as desired. In various embodiments, such database systems may use any suitable computing hardware and database management system software as desired. For example, in some embodiments, any of the various database systems herein may comprise a relational database management system such as MYSQL, PostgreSQL, MS SQL Server, Oracle, Sybase, or any other suitable system. Database systems may also be accessible using any suitable query language, such as SQL, XQuery or others. A relational database typically contains a number of tables with inter-related information such that rows in one table may be associated with rows in another table by a common field such as a unique identifier. In alternative embodiments, any of the various types of oSQL database management systems may be used (such as Key-value Store systems, BigTable systems, Document-Store systems and Graph Database systems). In some embodiments, a Persistent Distributed Key-Value Store database management system may be particularly well-suited to addressing latency and scaling constraints. Examples of such systems include, but are not limited to, Virtuoso Universal Server, OpenLink Virtuoso, Membase, Memcached, MemcacheDB, Cassandra, Hbase Riak, Redis, and Couchbase.

As discussed in detail below, one or more client applications may be adapted to present various user interfaces to users. Such user interfaces may be based on information stored in the database 157 and/or received from various entities (e.g., client devices 105, network locations 115, third-party systems 120, and/or data systems 160). Accordingly, client applications may be written in any form of programming language, including compiled or interpreted languages, or declarative or procedural languages, and it can be deployed in any form, including as a standalone program or as a module, component, subroutine, or other unit suitable for use in a computing environment.

The client application(s) can be deployed and/or executed on one or more computing devices that are located at one site or distributed across multiple sites and interconnected by a communication network. In one embodiment, a client application(s) may be installed on (or accessed by) one or more client devices. It will be apparent to one of ordinary skill in the art that, in certain embodiments, any of the functionality of a client may be incorporated into a central server, and vice versa. Likewise, any functionality of a client application may be incorporated into a browser-based client, and such embodiments are intended to be fully within the scope of this disclosure. For example, a browser-based client application could be configured for offline work by adding local storage capability, and a native application could be distributed for various native platforms (e.g., Microsoft Windows™, Apple Mac OS™, Google Android™ or Apple IOS™) via a software layer that executes the browser-based program on the native platform.

### Identifying Visitors and Providing Leads to Vendors

Referring to FIG. 2, an exemplary method 200 of identifying visitors to a network location is illustrated.

As shown, the method may begin at step 201, where a visitor may use a website and may opt in to receive promotions from a brand partner from a network. The visitor may then, at step 202, be assigned a unique identifier that may be linked to a characteristic of the web browser.

At step 203, the visitor may visit the network location having a vendor-specific script installed thereon. The visitor may then put an item in their shopping cart (e.g., via an “add to cart,” “add,” etc. button) that is located on the website and then may leave the website at step 204.

Generally, the service may receive user information (e.g., via the script) at step 205, determine a subset of the received user information that uniquely identifies a client device and data based on the shopping cart. The service may also receive user information on what user operates such device (e.g., email address, device fingerprints, etc.) at step 210, and index such identifying information to a user record stored in a user database at step 215.

When a user interacts with a network location, the user discloses various user information, some of which may be unique and/or intrinsic to the user or a particular client device associated with the user. Accordingly, at step 205, the user identification and monitoring service begins collecting user information about the user via the installed script.

In one embodiment, the system may receive an email address or a hash thereof when a user visits the network location via a content link (e.g., a URL included in an email template). In modern email systems, an email recipient can be identified by their email address or by some other unique identifier, such as an encrypted hash of their email address. Importantly, such identification may be passed from the email application to a network location.

As an example, a user may receive an email that includes one or more content links directed to the vendor's network location (e.g., a landing page). When the user clicks or otherwise selects one of the content links in the email, they may be directed to the corresponding network location URL. The email system may have the ability to pass the identifier of the user and any available targeting data from first-, second-, and third-party sources, along with the URL address through to the landing page. Accordingly, the service may check the URL of the content landing page to sec if it contains an identifier (e.g., an email address) and, if so, the identifier may be collected.

In another embodiment, the service may receive and/or determine various device parameters. For example, the system may capture device parameters such as, but not limited to: a device type identifier, a particular device ID (such as Apple's Identifier for Advertising (“IDFA”) and Google's Androidld or Advertising ID), first or third party identifiers, client supplied identifiers, contextual data (e.g., location data and/or network information), IP addresses, timestamps, time-differential linking (“TDL”) data, Latitude/Longitude coordinates (either provided directly or indirectly via an IP address), language settings, a cookie identifier, and/or any other parameter associated with a device.

Additionally, in cases where a user downloads software provided by the vendor or service provider, such software maybe be employed to detect certain additional device parameters. For example, the software may detect the serial number of the device CPU, motherboard, hard disk drive, and MAC address of the network card. The software can also detect the device's local IP address assigned by an Internet Service Provider (“ISP”).

In other embodiments, the service may receive user information entered by a user. For example, a user may provide personal information (e.g., first name, last name, phone number, mailing address, billing address, etc.) by filling out a form on the vendor's website.

In any event, once the service receives and/or determines user information for a user, one or more unique identifiers may be determined for the user based on such information at step 210. The unique identifiers may then be compared to user records stored in the user database(s) in order to determine a matching user record at step 215.

In embodiments where the URL contains an email address, such information may be stripped from the URL and hashed (e.g., via an MD5 hashing algorithm). In such cases, the email hash may already be associated with a user record stored in the user database. Accordingly, the service may quickly identify the user by matching the determined hashed email to a user record associated with the hashed email address in the user database.

In embodiments where device parameters are employed, the service may determine a subset of device parameters that uniquely identify the client device and a user who operates such devices (i.e., “fingerprints”). In one embodiment, a set of such fingerprints is determined from device parameters collected for a user. For example, the system may employ some or all of the following device parameters as fingerprints: IP address, websites visited, online activity during a given time of day, screen resolution, browser type, browser version, geolocation data, WiFi network information, Mobile Ad IDs, and/or operating system information.

In some embodiments, the user identification module may employ any of the various device fingerprinting techniques for consistently recognizing and identifying returning leads (e.g., users or devices). U.S. Pat. No. 6,496,824 titled “Session Management Over A Stateless Protocol,” which is incorporated by reference herein in its entirety, illustrates and describes a system for maintaining state over a stateless protocol by identifying unique users based on unique device fingerprints.

U.S. patent application Ser. No. 13/530,989 titled “Systems And Methods For Identifying A Returning Web Client,” which is also incorporated by reference herein in its entirety, illustrates and describes systems, methods and data structures for rapidly identifying a matching device fingerprint of a returning client device in order to recognize returning leads or to identify a visiting client device as a first-time-visitor within milliseconds. In some embodiments, such device information may be further correlated with user profile information (such as a list of client devices from which a single user has signed on to a service) to associate multiple recognized devices with a single user (or lead). Moreover, if available, the following personal information may additionally or alternatively be employed to create unique identifiers: first name, last name, postal addresses, Placekey IDs, and/or phone numbers.

It will be appreciated that, by employing fingerprints to uniquely identify each user, the service may reliably recognized users when only anonymous device parameters are available. Moreover, when such fingerprints are combined with email addresses and other personal information, the service may recognize and link user information received from any number of data sources to a single user.

Although not shown, the service may employ various logic to trigger the collection and/or analysis of user information. In one such embodiment, the service may not begin the identification process until: (1) an exit event occurs where the user navigates away from the network location and (2) a predetermined amount of time (e.g., 15 minutes) expires after the exit event. In another such embodiment, the service may wait to begin the identification process until a user navigates the network location for at least a predetermined amount of time (e.g., 15 minutes) without taking an identifying action (e.g., login, order, form submission, etc. that includes the user's email address). In another such embodiment, the service may begin the identification process when the user adds items to their eCommerce shopping cart (via an “add to cart,” “add,” etc. button). It will be appreciated that, in the above embodiments, the predetermined amount of time may be specified by an admin user or may be dynamically determined by the service.

Still referring to FIG. 2, the service next determines whether a matching user record exists in the database 220. Typically, a match will be determined when a determined user identifier is equal to a stored identifier (e.g., a hashed email address). However, in one embodiment where fingerprints are employed, the service may assign weights to each of the determined fingerprints when calculating whether the determined fingerprints match or otherwise correspond to stored fingerprints associated with a given user record.

In any event, if a matching record is found and either (a) the service has determined an email address for the user at step 210 or (b) the matching record includes an email address, the method may continue to step 235. Otherwise, the system may optionally create a new user record associated with the determined unique identifier(s) and any received/determined user information and store the same in the user database 225 before exiting.

At step 230, the service determines whether a suppression record exists for the identified user. As detailed below, the system may be configured to refrain from sharing personal information of users associated with a suppression record in the database. Accordingly, if the service determines that the matching user record is associated with a suppression record, the method may end 299. Otherwise, the method may continue to step 235.

At step 235, the service determines whether the email address associated with the matching user record (i.e., the “matching email address”) is valid. Generally, the service may perform validation checks on email addresses to ensure the addresses are deliverable and in good standing. In some embodiments, a third-party email validation system may be employed, such as but not limited to ZeroBounce or Klean13.

In one embodiment, the service may be configured to validate email addresses at least every three months. Accordingly, the service may determine a date of the most recent validation check performed for the matching email address and the system may revalidate the email when such date is more than three months prior to the current date.

As shown, the method may end 299 if the matching email address is determined to be invalid. Otherwise, the method may continue to step 240.

At step 240, the service may filter out matching email addresses based on one or more filtering rules set by a provider of the service and/or received from the vendor. For example, the service may filter email addresses that have not opened or clicked tracked marketing emails within a certain amount of time (e.g., the past 14 day). As another example, the service may filter email addresses associated with particular domains (e.g., aol.com, hotmail.com, etc.). As shown, the method may end 299 if the matching email address does not satisfy the filtering rules. Otherwise, the method may continue to step 241.

At step 241, the service may determine whether a suppression record exists for the identified user. As detailed below, the system may be configured to refrain from sharing personal information of users associated with a suppression record in the database. If the suppression record does exist, then the method may continue to step 250. Otherwise, the method may continue to step 245.

At step 245, the service may then create a lead record from the matching user record and transmit the same to a vendor. The service may then proceed to step 250.

At step 250, the service may create a record, an abandonment event, indicating that the user's cart has been abandoned. The service may then transmit the abandonment event to a vendor.

At step 255, the system may retrieve and/or determine various user information associated with the matching record in order to generate a lead record that may be provided to the vendor. Generally, the lead record will comprise at least the matching email address and the material in their shopping cart before leaving the website. However, in one embodiment, the lead record may comprise any number of additional user information (i.e., enrichment information) as desired or required by a vendor.

Exemplary enrichment information may include, but is not limited to: first name, last name, address, phone number, designated marketing area (DMA), age, gender, income level, education level, voter registration status, age, gender, income level, etc. Any of these pieces of information, information derived from these, or any other data may be associated with a user record in the database and/or included in a given lead record. It will be appreciated that, in some embodiments, such information may not be stored in the user database; rather, the service may simply connect to a third-party system (e.g., Infutor) in order to retrieve enhancement information for a lead record before transmitting the same to the vendor.

In any event, upon generating the lead record, the service transmits the same to the vendor (i.e., to one or more systems associated with the vendor). In various embodiments, the service may transmit the lead record to one or more of: CRM systems, advertising platforms, social media platforms, email systems and databases, analytics platforms, billing, accounting and/or payment systems, file sharing systems, etc. Additionally or alternatively, the service may display the lead records via one or more client applications and/or reporting interfaces accessible by the vendor.

It will be appreciated that the service may perform any number of additional or alternative steps to those listed above. For example, in one embodiment where a vendor subscribes to the service and is provided a certain number of leads (e.g., 1000 leads per month), the service may decrement a count of available leads associated with the vendor's account upon sharing a lead with the vendor. In such case, the service may determine whether the number of available leads is less than or equal to 0 and, if so, the service may disable the script associated with the vendor until the next billing period or until an additional payment is received from the vendor.

### Monitoring User Activity

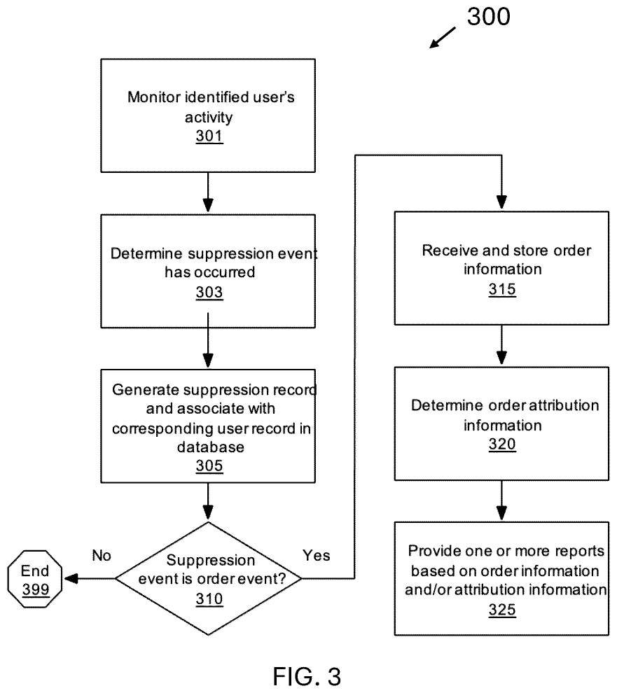

Referring to FIG. 3, an exemplary method of monitoring user activity based on predetermined events is illustrated. As shown, the method begins at step 301, where the service tracks an identified user's activity via a script installed at a vendor network location. It will be appreciated that the user may be identified according to any of the identification methods described above.

Generally, the service may include features and systems for identifying and tracking activities performed by users based on predefined events. In one such embodiment, the service may monitor and record information relating to one or more visits to determine the occurrence of a suppression event, such as an identifying event and/or an opt-out 303.

An identifying event refers to activity within a network location where a user discloses personal information, including an email address, to a vendor. Exemplary identifying activities may include, but are not limited to, filling out a contact form, subscribing to a service, making a reservation, and signing up for an account. Identifying events may also include order events, such as purchasing goods or services in one-time transactions or as one or more up-sells (e.g., a premium add-on service).

In one embodiment, the service may provide functionality to permit users to opt-out of allowing their personal information (e.g., email address) to be shared with vendors. Similarly, users may opt out of being behaviorally tracked or targeted by the service. In such cases, various input forms may be made available to users, for example, via notification or the like. And a user may utilize such forms to indicate an opt-out preference, which is received by the service.

In some embodiments, the service may provide an API that allows vendors to offer such opt-out functionality to network location visitors. The opt-out feature may be global (e.g., all websites, all networks, etc.) or it may be specific to a particular vendor.

The service may also be configured to determine suppression events based on system parameters and/or a status of a given user record. For example, the system may determine that a suppression event has occurred upon any of the following: a corresponding lead record is shared with a vendor, an email addresses associated with a user record cannot be verified or does not pass a vendor filter, and/or the email address is known to a vendor (e.g., the email already exists in a vendor's system).

In any event, upon determining that a suppression event has occurred, the service may generate a suppression record and associate the same with the corresponding user record in the database 305. Such suppression record may cause the service to refrain from sharing the user record with the vendor (or with all vendors in the case of a global opt-out) in the future.

In some embodiments, the service may perform additional steps with respect to order events, such as purchasing goods or services. Accordingly, at step 310, the service may determine whether the suppression event is an order event. If it is not, the method may end 399. Otherwise, the method may continue to step 315.

At step 315, the service receives and stores order information associated with the order event. Exemplary order information may include, but is not limited to: item purchased, price, quantity sold, purchase date, billing information, user information of the purchaser, etc.

At step 320, the service determines attribution information relating to the order. In one embodiment, the system may associate or otherwise connect the order to the service provider when the purchaser is a lead whose information was shared with the vendor at least a predetermined amount of time before the purchase (e.g., at least 12 hours or at least 24 hours prior to the purchase).

Finally, at step 325, the service may employ the order information and/or the attribution information to generate one or more reports. Such reports may be based on aggregate lead, order/purchase, and/or billing information (e.g., return on investment, percent sales attributable to the service, etc.). It will be appreciated that such data may be analyzed and presented (e.g., transmitted or displayed) using any suitable means available.

In one embodiment, the system may provide one or more reports comprising information pertaining to: total revenue, ROI, leads added to cart, leads ordered, suppressed leads, collected leads, tracked leads, and/or other information. It will be appreciated that such information may be presented according to various time frames, for example, daily, weekly, monthly, annually, etc.

It will be further appreciated that, in certain embodiments, the service may dynamically receive information from and/or send information to, any systems associated with a vendor. For example, the service may make API calls to connected systems to pull new contacts (e.g., contacts added by the vendor). Accordingly, the service may create user records for new contacts and/or update user records for new contacts, where the new/updated records are associated with a suppression record to ensure that the users are not suggested to the vendor by the service. Moreover, the service may perform the above method in response to receiving new/updated information from a vendor system (e.g., the system may create a suppression record for a new contact added from a vendor system).

### Client Applications

In certain embodiments, the service may provide one or more client applications. Exemplary client applications may include, but are not limited to, a vendor application and/or an administration application.

A vendor application may be provided to allow vendor users to view various information and set system preferences. This application may allow vendors to specify information such as: connections to various data sources (e.g., via input of data source information), users and associated user information, suppression information, billing information, etc. Moreover, the vendor application may be configured to display any of the reports, user information and/or preferences information discussed above.

An exemplary administration application may display various user interface elements to allow administrative users to view and update stored user records. In one embodiment, this application may allow users to search a user population to find users who match specific criteria (e.g., personal information, suppression information, lead status, etc.). In another embodiment, this application may allow users to create various reports comprising charts, graphs, tables, and/or other components relating to the user information.

### Computing Device

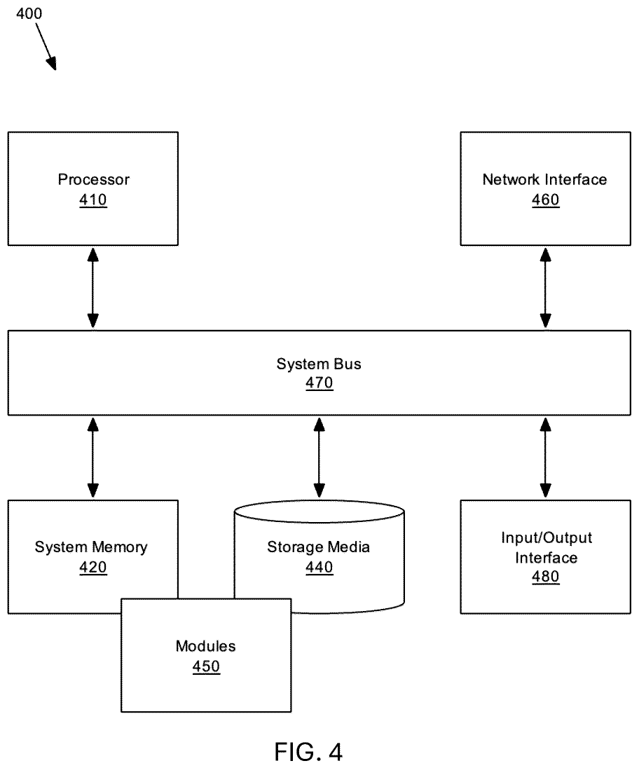

Referring to FIG. 4, a block diagram is provided illustrating a computing device 400 and modules 450 in accordance with one or more embodiments presented herein. The computing device 400 may correspond to any of the various computers, servers, mobile devices, embedded systems, or computing systems presented herein (e.g., the client device(s) 105 and/or various components 151-156 of the service 150 shown in FIG. 1). And the modules 450 may comprise one or more hardware or software elements configured to facilitate the computing device(s) 400 in performing the various methods and processing functions presented herein.

The computing device 400 may comprise all kinds of apparatuses, devices, and machines for processing data, including but not limited to, a programmable processor, a computer, and/or multiple processors or computers. For example, the computing device 400 may be implemented as a conventional computer system, an embedded controller, a laptop, a server, a mobile device, a smartphone, a tablet, a wearable device, a kiosk, one more processors associated with a display, a customized machine, any other hardware platform and/or combinations thereof. Moreover, a computing device may be embedded in another device, such as the above-listed devices and/or a portable storage device (e.g., a universal serial bus (“USB”) flash drive). In some embodiments, the computing device 400 may be a distributed system configured to function using multiple computing devices interconnected via a data network or system bus 470.

As shown, an exemplary computing device 400 may include various internal and/or attached components, such as a processor 410, system bus 470, system memory 420, storage media 440, input/output interface 480, and network interface 460 for communicating with a network.

The processor 410 may be configured to execute code or instructions to perform the operations and functionality described herein, manage request flow and address mappings, and to perform calculations and generate commands. The processor 410 may be configured to monitor and control the operation of the components in the computing device 400. The processor 410 may be a general-purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 410 may be a single processing unit, multiple processing units, a single processing core, multiple processing cores, special purpose processing cores, coprocessors, or any combination thereof. In addition to hardware, exemplary apparatuses may comprise code that creates an execution environment for the computer program (e.g., code that constitutes one or more of: processor firmware, a protocol stack, a database management system, an operating system, and a combination thereof). According to certain embodiments, the processor 410 and/or other components of the computing device 400 may be a virtualized computing device executing within one or more other computing devices.

The system memory 420 may include non-volatile memories such as read-only memory (“ROM”), programmable ROM, erasable programmable ROM, flash memory, or any other device capable of storing program instructions or data with or without applied power. The system memory 420 also may include volatile memories, such as various types of random-access memory (“RAM”). The system memory 420 may be implemented using a single memory module or multiple memory modules. While the system memory is depicted as being part of the computing device 400, one skilled in the art will recognize that the system memory may be separate from the computing device without departing from the scope of the subject technology. It should also be appreciated that the system memory may include, or operate in conjunction with, a non-volatile storage device such as the storage media 440.

The storage media 440 may include a hard disk, a compact disc, a digital versatile disc (“DVD”), a Blu-ray disc, a magnetic tape, a flash memory, other non-volatile memory device, a solid-state drive (“SSD”), any magnetic storage device, any optical storage device, any electrical storage device, any semiconductor storage device, any physical-based storage device, any other data storage device, or any combination/multiplicity thereof. The storage media 440 may store one or more operating systems, application programs and program modules such as module, data, or any other information. The storage media may be part of, or connected to, the computing device 400. The storage media may also be part of one or more other computing devices that are in communication with the computing device such as servers, database servers, cloud storage, network attached storage, and so forth.

The modules 450 may comprise one or more hardware or software elements configured to facilitate the computing device 400 with performing the various methods and processing functions presented herein. The modules 450 may include one or more sequences of instructions stored as software or firmware in association with the system memory 420, the storage media 440, or both. The storage media 440 may therefore represent examples of machine or computer readable media on which instructions or code may be stored for execution by the processor. Machine or computer readable media may generally refer to any medium or media used to provide instructions to the processor. Such machine or computer readable media associated with the modules may comprise a computer software product. It should be appreciated that a computer software product comprising the modules may also be associated with one or more processes or methods for delivering the module to the computing device via the network, any signal-bearing medium, or any other communication or delivery technology. The modules 450 may also comprise hardware circuits or information for configuring hardware circuits such as microcode or configuration information for an FPGA or other PLD.

The input/output (“I/O”) interface 480 may be configured to couple to one or more external devices, to receive data from the one or more external devices, and to send data to the one or more external devices. Such external devices along with the various internal devices may also be known as peripheral devices. The I/O interface 480 may include both electrical and physical connections for operably coupling the various peripheral devices to the computing device 400 or the processor 410. The I/O interface 480 may be configured to communicate data, addresses, and control signals between the peripheral devices, the computing device, or the processor. The I/O interface 480 may be configured to implement any standard interface, such as small computer system interface (“SCSI”), serial-attached SCSI (“SAS”), fiber channel, peripheral component interconnect (“PCI”), serial bus, parallel bus, advanced technology attachment (“ATA”), serial ATA (“SATA”), USB, Thunderbolt, FireWire, various video buses, and the like. The I/O interface may be configured to implement only one interface or bus technology. Alternatively, the I/O interface may be configured to implement multiple interfaces or bus technologies. The I/O interface may be configured as part of, all of, or to operate in conjunction with, the system bus 470. The I/O interface 180 may include one or more buffers for buffering transmissions between one or more external devices, internal devices, the computing device 400, or the processor 410.

The I/O interface 480 may couple the computing device 400 to various input devices including mice, touch-screens, scanners, biometric readers, electronic digitizers, sensors, receivers, touchpads, trackballs, cameras, microphones, keyboards, any other pointing devices, or any combinations thereof. When coupled to the computing device, such input devices may receive input from a user in any form, including acoustic, speech, visual, or tactile input.

The I/O interface 480 may couple the computing device 400 to various output devices such that feedback may be provided to a user via any form of sensory feedback (e.g., visual feedback, auditory feedback, or tactile feedback). For example, a computing device can interact with a user by sending documents to and receiving documents from a device that is used by the user (e.g., by sending web pages to a web browser on a user's client device in response to requests received from the web browser). Exemplary output devices may include, but are not limited to, displays, speakers, printers, projectors, tactile feedback devices, automation control, robotic components, actuators, motors, fans, solenoids, valves, pumps, transmitters, signal emitters, lights, and so forth. And exemplary displays include, but are not limited to, one or more of: projectors, cathode ray tube (“CRT”) monitors, liquid crystal displays (“LCD”), light-emitting diode (“LED”) monitors and/or organic light-emitting diode (“OLED”) monitors.

Embodiments of the subject matter described in this specification can be implemented in a computing device 400 that includes one or more of the following components: a backend component (e.g., a data server); a middleware component (e.g., an application server); a frontend component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network. Accordingly, the computing device 400 may operate in a networked environment using logical connections through the network interface 460 to one or more other systems or computing devices across a network.

The processor 410 may be connected to the other elements of the computing device 400 or the various peripherals discussed herein through the system bus 470. It should be appreciated that the system bus 470 may be within the processor, outside the processor, or both. According to some embodiments, any of the processor 410, the other elements of the computing device 400, or the various peripherals discussed herein may be integrated into a single device such as a system on chip (“SOC”), system on package (“SOP”), or ASIC device.

Embodiments of the subject matter and the functional operations described in this specification can be implemented in one or more of the following: digital electronic circuitry; tangibly-embodied computer software or firmware; computer hardware, including the structures disclosed in this specification and their structural equivalents; and combinations thereof. Such embodiments can be implemented as one or more modules of computer program instructions encoded on a tangible non-transitory program carrier for execution by, or to control the operation of, data processing apparatus (i.e., one or more computer programs). Program instructions may be, alternatively or additionally, encoded on an artificially generated propagated signal (e.g., a machine-generated electrical, optical, or electromagnetic signal) that is generated to encode information for transmission to suitable receiver apparatus for execution by a data processing apparatus. And the computer storage medium can be one or more of: a machine-readable storage device, a machine-readable storage substrate, a random or serial access memory device, and combinations thereof.

As used herein, the term “data processing apparatus” comprises all kinds of apparatuses, devices, and machines for processing data, including but not limited to, a programmable processor, a computer, and/or multiple processors or computers. Exemplary apparatuses may include special purpose logic circuitry, such as a field programmable gate array (“FPGA”) and/or an application specific integrated circuit (“ASIC”). In addition to hardware, exemplary apparatuses may comprise code that creates an execution environment for the computer program (e.g., code that constitutes one or more of: processor firmware, a protocol stack, a database management system, an operating system, and a combination thereof).

The term “computer program” may also be referred to or described herein as a “program,” “software,” a “software application,” a “module,” a “software module,” a “script,” or simply as “code.” A computer program may be written in any form of programming language, including compiled or interpreted languages, or declarative or procedural languages, and it can be deployed in any form, including as a standalone program or as a module, component, subroutine, or other unit suitable for use in a computing environment. Such software may correspond to a file in a file system. A program can be stored in a portion of a file that holds other programs or data. For example, a program may include one or more scripts stored in a markup language document; in a single file dedicated to the program in question; or in multiple coordinated files (e.g., files that store one or more modules, sub programs, or portions of code). A computer program can be deployed and/or executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as but not limited to an FPGA and/or an ASIC.

Computers suitable for the execution of the one or more computer programs include, but are not limited to, general purpose microprocessors, special purpose microprocessors, and/or any other kind of central processing unit (“CPU”). Generally, CPU will receive instructions and data from a read only memory (“ROM”) and/or a random access memory (“RAM”). The essential elements of a computer are a CPU for performing or executing instructions and one or more memory devices for storing instructions and data. Generally, a computer will also include, or be operatively coupled to receive data from or transfer data to, or both, one or more mass storage devices for storing data (e.g., magnetic, magneto optical disks, and/or optical disks). However, a computer need not have such devices. Moreover, a computer may be embedded in another device, such as but not limited to, a mobile telephone, a personal digital assistant (“PDA”), a mobile audio or video player, a game console, a Global Positioning System (“GPS”) receiver, or a portable storage device (e.g., a universal serial bus (“USB”) flash drive).

Computer readable media suitable for storing computer program instructions and data include all forms of nonvolatile memory, media and memory devices. For example, computer readable media may include one or more of the following: semiconductor memory devices, such as erasable programmable read-only memory (“EPROM”), electrically erasable programmable read-only memory (“EEPROM”) and/or and flash memory devices; magnetic disks, such as internal hard disks or removable disks; magneto optical disks; and/or CD-ROM and DVD-ROM disks. The processor and the memory can be supplemented by, or incorporated in, special purpose logic circuitry.

To provide for interaction with a user, embodiments may be implemented on a computer having any type of display device for displaying information to a user. Exemplary display devices include, but are not limited to one or more of: projectors, cathode ray tube (“CRT”) monitors, liquid crystal displays (“LCD”), light-emitting diode (“LED”) monitors and/or organic light-emitting diode (“OLED”) monitors. The computer may further comprise one or more input devices by which the user can provide input to the computer. Input devices may comprise one or more of: keyboards, a pointing device (e.g., a mouse or a trackball). Input from the user can be received in any form, including acoustic, speech, or tactile input. Moreover, feedback may be provided to the user via any form of sensory feedback (e.g., visual feedback, auditory feedback, or tactile feedback). A computer can interact with a user by sending documents to and receiving documents from a device that is used by the user (e.g., by sending web pages to a web browser on a user's client device in response to requests received from the web browser).

Embodiments of the subject matter described in this specification can be implemented in a computing system that includes one or more of the following components: a backend component (e.g., a data server); a middleware component (e.g., an application server); a front end component (e.g., a client computer having a graphical user interface (“GUI”) and/or a web browser through which a user can interact with an implementation of the subject matter described in this specification); and/or combinations thereof. The components of the system can be interconnected by any form or medium of digital data communication, such as but not limited to, a communication network. Non-limiting examples of communication networks include a local area network (“LAN”) and a wide area network (“WAN”), e.g., the Internet.

The computing system may include clients and/or servers. The client and server may be remote from each other and interact through a communication network. The relationship of client and server arises by virtue of computer programs running on the respective computers and having a client-server relationship to each other.

Various embodiments are described in this specification, with reference to the detailed discussed above, the accompanying drawings, and the claims. Numerous specific details are described to provide a thorough understanding of various embodiments. However, in certain instances, well-known or conventional details are not described in order to provide a concise discussion. The figures are not necessarily to scale, and some features may be exaggerated or minimized to show details of particular components. Therefore, specific structural and functional details disclosed herein are not to be interpreted as limiting, but merely as a basis for the claims and as a representative basis for teaching one skilled in the art to variously employ the embodiments.

The embodiments described and claimed herein and drawings are illustrative and are not to be construed as limiting the embodiments. The subject matter of this specification is not to be limited in scope by the specific examples, as these examples are intended as illustrations of several aspects of the embodiments. Any equivalent examples are intended to be within the scope of the specification. Indeed, various modifications of the disclosed embodiments in addition to those shown and described herein will become apparent to those skilled in the art, and such modifications are also intended to fall within the scope of the appended claims.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

All references, including patents, patent applications and publications cited herein are incorporated herein by reference in their entirety and for all purposes to the same extent as if each individual publication or patent or patent application was specifically and individually indicated to be incorporated by reference in its entirety for all purposes.

What is claimed is:

1. A system for user identification and monitoring, the system comprising:
a processor;
a memory; and
instructions stored on the memory, the instructions, when executed by the processor, cause the processor to:
identify visitors to a website or other network location across a plurality of user devices and applications,
wherein identifying visitors to the website or other network locations across a plurality of user devices and applications includes:
a script management module,
wherein the script management module manages a number of vendor-specific scripts;
a user identification module,
wherein the user identification module uniquely identifies visitors to a network based on a user's selection to opt in for one or more promotions and associate each identified visitor with a unique identifier;
an activity tracking module,
wherein the activity tracking module monitors activities of visitors identified by the user identification module;
a suppression module,
wherein the suppression module receives and determines suppression information relating to a user corresponding to user records stored in a user database;
an attribution module,
wherein the attribution module associates an abandoned eCommerce cart made by the visitor at a network location with a provider of a service based on predetermined attribution criteria; and
a reporting module,
wherein the reporting module transmits or displays some or all user information contained in one or more of the user records via one or more reports, notifications, alerts, webhooks, or API calls.

2. The system of claim 1, wherein the script management module further manages configuration settings and data supporting the vendor-specific scripts.

3. The system of claim 2, wherein the script management module further generates a unique script for each vendor.

4. The system of claim 1, wherein the script management module further generates a unique script for each vendor.

5. The system of claim 1, wherein the user identification module further receives user information, determines a subset of the received user information that uniquely identifies a client device or user of the client device, and matches the subset of the received user information to the user records.

6. The system of claim 5, wherein the user identification module further creates the user record in the user database corresponding to the unique identifier.

7. The system of claim 1, wherein the activity tracking module further tracks visits to a network location, and use and conversion activities performed by a user.

8. The system of claim 7, wherein the activity tracking module associates the visit, use, and conversion information with the corresponding user record on the user database.

9. The system of claim 1, wherein the activity tracking module further identifies and tracks activities performed by the user based on one or more predetermined events.

10. The system of claim 1, wherein the reporting module further determines aggregate information across a user population, or subset thereof, based on the user records and tracked activities performed by the user.

11. A method for tracking user activities across user devices, the method comprising:
identifying visitors to a website or other network location across a plurality of user devices and applications,
wherein identifying visitors to the website or other network locations across a plurality of user devices and applications includes:
assigning the user to a unique identifier, via a user identification module, configured to be linked to a characteristic of the website;
managing, via a script management module, a number of vendor-specific scripts;
logging, via user activity, items put into an eCommerce cart on the website;
logging, via user activity, an abandonment of the eCommerce cart;
uniquely identifying, via a user identification module, visitors to a network and associate each identified visitor with a unique identifier;
monitoring, via an activity tracking module, activities of visitors identified by the user identification module;
receiving and determining, via a suppression module, suppression information relating to a user corresponding to user records stored in a user database;
associating, via an attribution module, the abandoned eCommerce cart made by the visitor at a network location with a provider of a service based on predetermined attribution criteria; and
transmitting or displaying, via a reporting module, some or all user information contained in one or more of the user records via one or more reports, notifications, alerts, webhooks, or API calls.

12. The method of claim 11, wherein the method further includes managing, via the script management module, configuration settings and data supporting the vendor-specific scripts.

13. The method of claim 12, wherein the method further includes generating, via the script management module, a unique script for each vendor.

14. The method of claim 11, wherein the method further includes generating, via the script management module, a unique script for each vendor.

15. The method of claim 11, wherein the method further includes receiving, via the user identification module, user information, determining a subset of the received user information that uniquely identifies a client device or user of the client device, and matching the subset of the received user information to the user records.

16. The method of claim 15, wherein the method further includes creating, via the user identification module, the user record in the user database corresponding to the unique identifier.

17. The method of claim 11, wherein the method further includes tracking, via the activity tracking module, visits to a network location, and use and conversion activities performed by a user.

18. The method of claim 17, wherein the method further includes associating, via the activity tracking module, the visit, use, and conversion information with the corresponding user record on the user database.

19. The method of claim 11, wherein the method further includes identifying and tracking, via the activity tracking module, activities performed by the user based on one or more predetermined events.

20. The method of claim 11, wherein the method further includes determining, via the reporting module, aggregate information across a user population, or subset thereof, based on the user records and tracked activities performed by the user.
